(19) United States
(12) Patent Application Publication
(10) Pub. No.: US 2013/0287407 A1
(43) Pub. Date: Oct. 31, 2013

(54) Hybrid Multichannel or WDM Integrated Transceiver

(71) Applicant: SIFOTONICS TECHNOLOGIES CO., LTD., Woburn, MA (US)

(72) Inventors: Dong Pan, Andover, MA (US); Yanwu Zhang, Beijing (CN)

(73) Assignee: SiFotonics Technologies Co., Ltd., Woburn, MA (US)

(21) Appl. No.: 13/871,877

(22) Filed: Apr. 26, 2013

Related U.S. Application Data
(60) Provisional application No. 61/687,606, filed on Apr. 27, 2012.

(51) Int. Cl. H04B 10/40

(52) U.S. Cl. CPC H04B 10/40
USPC 398/139

(57) ABSTRACT

Various embodiments of a hybrid multichannel or WDM integrated transceiver are presented. In one aspect, a transceiver includes a transmitter portion and a receiver portion. The transmitter portion includes an optical waveguide structure that includes multiple channels of optical waveguide modulators on a substrate. The receiver portion includes at least one surface light illuminated photodetector.

### CROSS-REFERENCE TO RELATED PATENT APPLICATIONS

This application is the non-provisional application or, and claims the priority benefit of, U.S. Patent Application Ser. No. 61/687,606, entitled “A hybrid multichannel or WDM integrated transceiver”, filed on Apr. 27, 2012, which is herein incorporated by reference in its entirety.

### BACKGROUND

1. Technical Field

The present disclosure relates to optical communications. More particularly, the present disclosure relates to a hybrid multichannel or wavelength-division multiplexing (WDM) transceiver.

2. Description of Related Art

One of the two conventional ways of making multichannel or WDM transceivers is to use and place various discrete devices into one packaging, which includes multiple discrete optical transmission devices, multiple discrete photo detector devices as well as a discrete multiplexing or de-multiplexing device. The multiplexing or de-multiplexing device is generally a thin film filter. FIG. 1 illustrates an example of such a conventional transceiver 100.

The other conventional way of making multichannel or WDM transceivers is to integrate multiple optical transmission channels and receiver channels with a multiplexing or de-multiplexing device together on the same wafer using optical waveguide. FIG. 2a illustrates an example of such a conventional transceiver 210. FIG. 2b illustrates another example structure of a conventional transceiver 220, in which multiple transmission devices are integrated with receiver devices on the same wafer with an optical multiplexing or de-multiplexing device using optical waveguide. However, the conventional approaches to integration tend to suffer from technological difficulties, such as polarization control and coupler issue.

### SUMMARY

According to the present disclosure, a new structure of transceiver includes a transmitter portion and a receiver portion. The transmitter portion includes multiple channels of optical waveguide modulators on the same substrate using optical waveguide form, being integrated with or arranged in parallel with an optical multiplexing structure. The receiver portion includes normal incident photodetectors or a photodetector array, combined with a discrete optical de-multiplexing structure which may be a thin film filter.

In one aspect, a transceiver may include a transmitter portion and a receiver portion. The transmitter portion may include an optical waveguide structure that includes multiple channels of optical waveguide modulators on a substrate. The receiver portion may include at least one surface light illuminated photodetector.

In at least one embodiment, the transmitter portion may further include an optical waveguide multiplexing structure, and the multiple channels of optical waveguide modulators may be integrated with the optical waveguide multiplexing structure into an optical channel for transmission. Alternatively, the transmitter portion may further include an optical waveguide multiplexing structure, and the multiple channels of optical waveguide modulators may be arranged in parallel with the optical waveguide multiplexing structure into multiple channels of couplers on the substrate. The multiple channels of optical waveguide modulators may include Si modulators, Ge/Si modulators, or element III-V based modulators. The substrate may include a Si substrate, and the multiple channels of optical waveguide modulators may include Si modulators. The optical waveguide multiplexing structure may include an arrayed waveguide grating (AWG), ring filter, echelle grating, or cascaded multiple stages of filters on the substrate.

In at least one embodiment, the optical waveguide structure may include multiple channels of lasers on a substrate. The transmitter portion may further include an optical waveguide multiplexing structure, and the multiple channels of lasers may be integrated with the optical waveguide multiplexing structure into an optical channel. Alternatively, the transmitter portion may further include an optical waveguide multiplexing structure, and the multiple channels of lasers may be arranged in parallel with the optical waveguide multiplexing structure into multiple channels of couplers on the substrate. The multiple channels of lasers may include element III-V lasers. The substrate may include an element III-V substrate, and the multiple channels of lasers may include element III-V based lasers. The optical waveguide multiplexing structure may include an AWG, ring filter, echelle grating, or cascaded multiple stages of filters on the substrate.

In at least one embodiment, the receiver portion may include numerous surface illuminated devices and a discrete optical de-multiplexing structure, and the surface illuminated devices may be connected with the discrete optical de-multiplexing structure to form an optical channel for receiving. The surface illuminated devices may include Ge/Si photodetectors or element III-V photodetectors. Alternatively, the surface illuminated devices may include discrete photodetectors or a detector array. The discrete optical de-multiplexing structure may include a thin film filter. The receiver portion may include numerous surface illuminated devices and a discrete optical de-multiplexing structure, and the surface illuminated devices and the discrete optical de-multiplexing structure may be arranged in parallel into multiple fibers. The surface illuminated devices may include Ge/Si photodetectors or element III-V photodetectors. The surface illuminated devices may include discrete photodetectors or a detector array. The discrete optical de-multiplexing structure may include a thin film filter.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure. The drawings may not necessarily be in scale so as to better present certain features of the illustrated subject matter.

FIG. 1 is a diagram of a conventional transceiver using discrete devices.

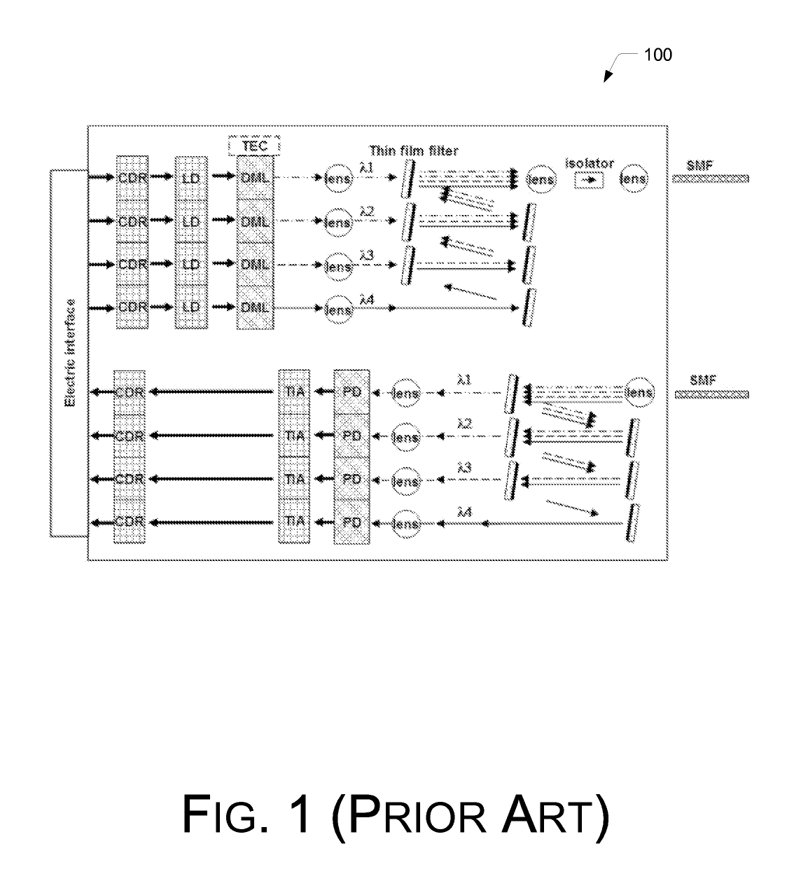

FIG. 2A is a diagram of a conventional transceiver using integrated devices.

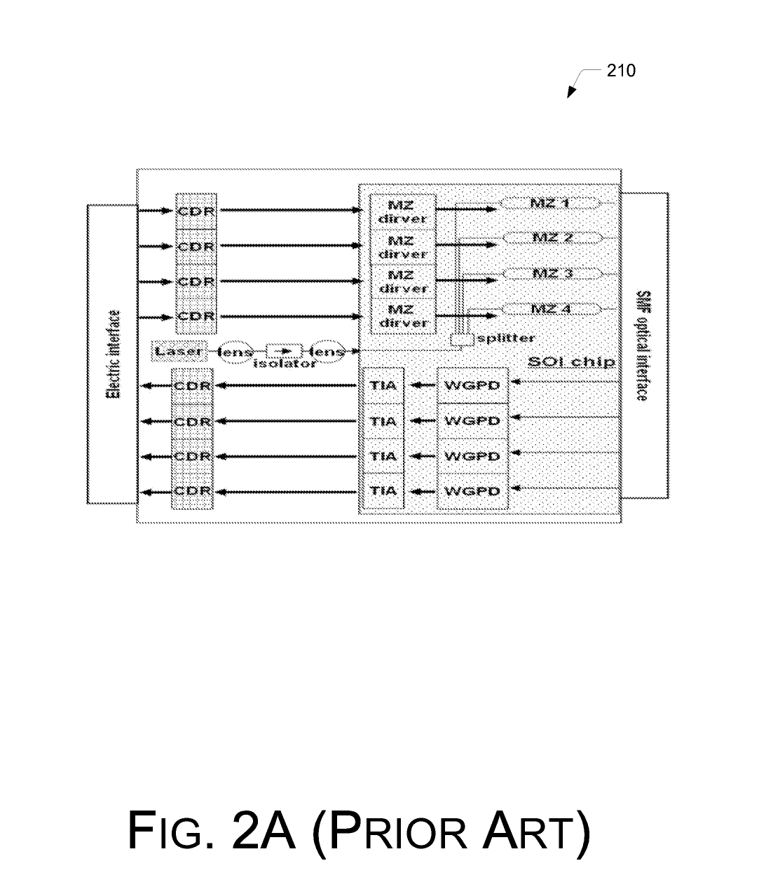

FIG. 2B is a diagram of another conventional transceiver using integrated devices.

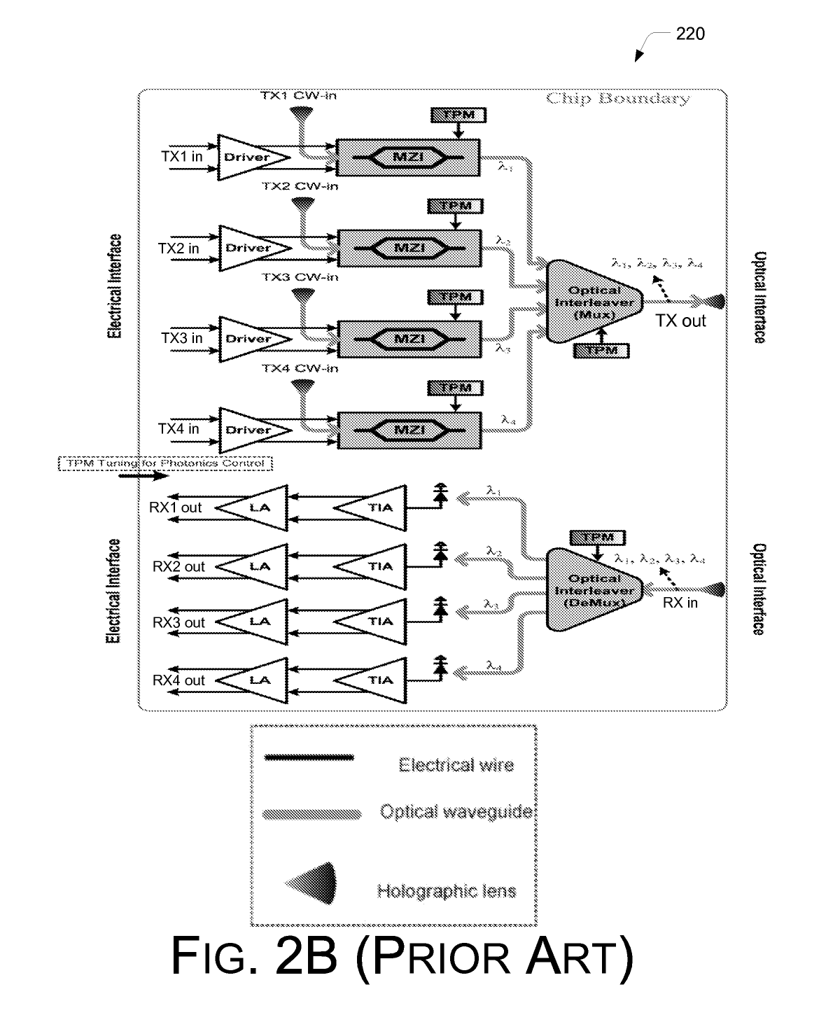

FIG. 3A is a diagram of a transceiver in accordance with the present disclosure of hybrid transceiver.

FIG. 3B is a diagram of another transceiver in accordance with the present disclosure of hybrid transceiver.

FIG. 4 is a diagram of yet another transceiver in accordance with the present disclosure of hybrid transceiver.

### DETAILED DESCRIPTION OF THE PREFERRED EMBODIMENTS

Overview

The present disclosure provides a new structure of hybrid multichannel transceiver includes a transmitter portion and a receiver portion. The transmitter portion includes multiple channels of optical waveguide modulators on the same substrate using optical waveguide form, being integrated with or arranged in parallel with an optical multiplexing structure. The receiver portion includes normal incident photodetectors or a photodetector array, combined with a discrete optical de-multiplexing structure which may be a thin film filter.

Example Implementations

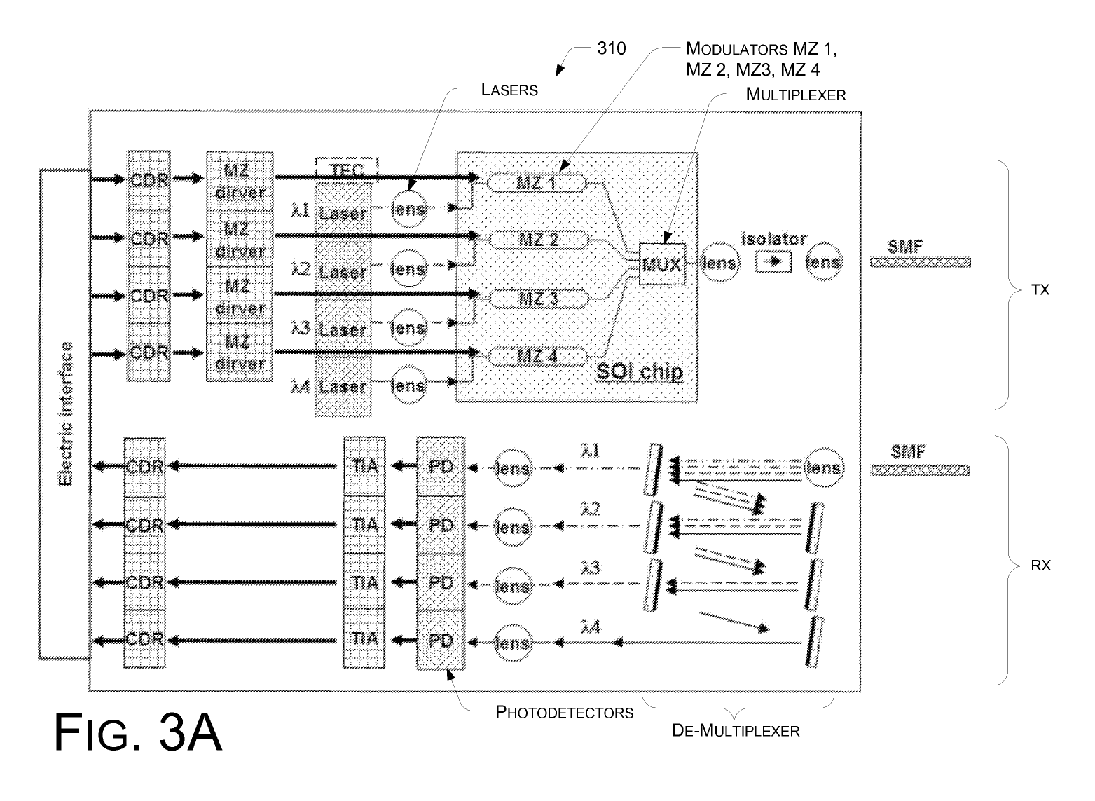

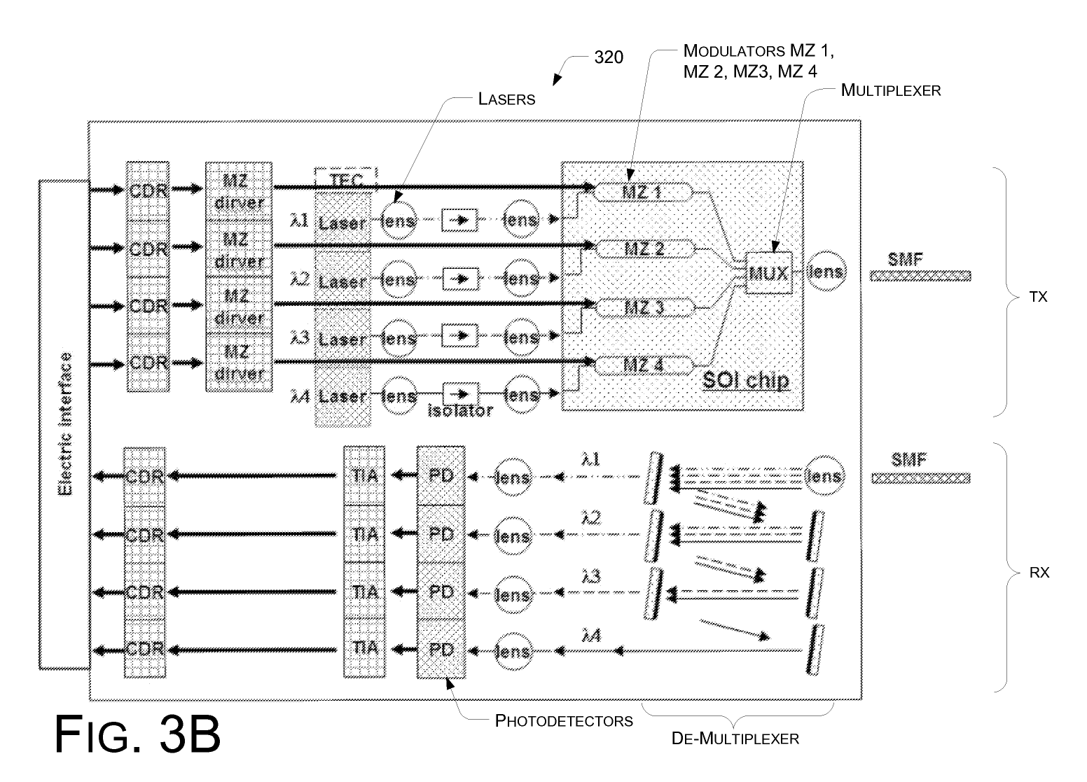

FIG. 3A illustrates a transceiver 310 in accordance with the present disclosure. FIG. 3B illustrates a transceiver 320 in accordance with the present disclosure.

As shown in FIG. 3A, transceiver 310 includes a transmitter portion (TX) and a receiver portion (RX). The transmitter portion includes an optical waveguide structure that includes multiple channels of optical waveguide modulators on a substrate. The receiver portion includes at least one surface light illuminated photodetector. Likewise, as shown in FIG. 3B, transceiver 320 includes a transmitter portion (TX) and a receiver portion (RX). The transmitter portion includes an optical waveguide structure that includes multiple channels of optical waveguide modulators on a substrate. The receiver portion includes at least one surface light illuminated photodetector. Transceiver 310 and transceiver 320 differ in that in transceiver 310 an isolator and an additional lens are used in the output of the transmitter portion, between a lens coupled to a chip and a single-mode fiber (SMF). In the interest of brevity, the description below pertains to both transceiver 310 and transceiver 320.

In at least one embodiment, the transmitter portion further includes an optical waveguide multiplexing structure, and the multiple channels of optical waveguide modulators is integrated with the optical waveguide multiplexing structure into an optical channel for transmission, e.g., coupled to a SMF. Alternatively, the multiple channels of optical waveguide modulators are arranged in parallel with the optical waveguide multiplexing structure into multiple channels of couplers on the substrate.

In the example shown in each of FIG. 3A and FIG. 3B, four modulators (MZ 1, MZ 2, MZ 3 and MZ 4) and a multiplexer (MUX) are integrated on the same chip, e.g., silicon-on-insulator (SOI) chip, with waveguide. The receiver portion of each of transceiver 310 and transceiver 320 includes four discrete photodetectors PD or a photodetector array with a de-multiplexer which may be, for example, a thin film filter.

In at least one embodiment, the multiple channels of optical waveguide modulators include silicon (Si) modulators, germanium/silicon (Ge/Si) modulators, or element III-V based modulators.

In at least one embodiment, the substrate includes a Si substrate, and the multiple channels of optical waveguide modulators include Si modulators.

In at least one embodiment, the optical waveguide multiplexing structure includes an arrayed waveguide grating (AWG), ring filter, echelle grating, or cascaded multiple stages of filters on the substrate.

In at least one embodiment, the optical waveguide structure includes multiple channels of lasers on a substrate.

In at least one embodiment, the transmitter portion further includes an optical waveguide multiplexing structure, and the multiple channels of lasers may be integrated with the optical waveguide multiplexing structure into an optical channel. Alternatively, the multiple channels of lasers are arranged in parallel with the optical waveguide multiplexing structure into multiple channels of couplers on the substrate.

In at least one embodiment, the multiple channels of lasers include element III-V lasers.

In at least one embodiment, the substrate includes an element III-V substrate, and the multiple channels of lasers include element III-V based lasers.

In at least one embodiment, the optical waveguide multiplexing structure include an AWG, ring filter, echelle grating, or cascaded multiple stages of filters on the substrate.

The transmitter portion of each of transceiver 310 and transceiver 320 also includes an array of clock and data recovery (CDR) modules, an array of modulator drivers (MZ drivers) coupled to the array of CDR modules, an array of lasers coupled to the array of MZ drivers, a first array of lenses, an array of isolators coupled to the first array of lenses, a second array of lenses coupled to the array of isolators, and a single chip of an optical waveguide multiplexing structure coupled to the second array of lenses. The array of lasers may be cooled by one or more thermoelectric cooling modules (TEC).

In at least one embodiment, the receiver portion includes numerous surface illuminated devices and a discrete optical de-multiplexing structure, and the surface illuminated devices are connected with the discrete optical de-multiplexing structure to form an optical channel for receiving.

In at least one embodiment, the surface illuminated devices include Ge/Si photodetectors or element III-V photodetectors. Alternatively, the surface illuminated devices include discrete photodetectors or a detector array.

In at least one embodiment, the discrete optical de-multiplexing structure includes a thin film filter.

In at least one embodiment, the receiver portion includes numerous surface illuminated devices and a discrete optical de-multiplexing structure, and the surface illuminated devices and the discrete optical de-multiplexing structure are arranged in parallel into multiple fibers.

In at least one embodiment, the surface illuminated devices include Ge/Si photodetectors or element III-V photodetectors.

In at least one embodiment, the surface illuminated devices include discrete photodetectors or a detector array.

In at least one embodiment, the discrete optical de-multiplexing structure includes a thin film filter.

The receiver portion of each of transceiver 310 and transceiver 320 also includes an array of lenses coupled to the de-multiplexing structure, an array of lenses coupled to the de-multiplexing structure, an array of photodetectors (PDs) coupled to the array of lenses, an array of trans-impedance amplifier (TIA) modules coupled to the array of PDs, and an array of CDR modules coupled to the array of TIA modules. At least the CDR modules and the TIA modules may be complementary metal-oxide-semiconductors (CMOS) and fabricated by CMOS process.

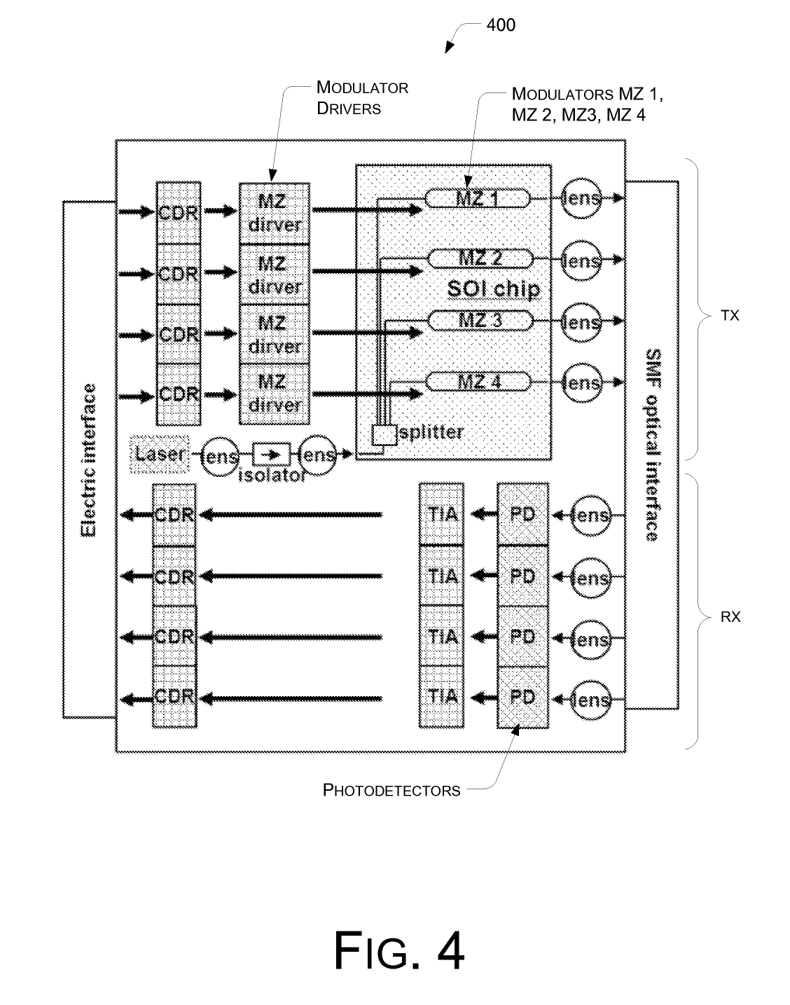

FIG. 4 illustrates a transceiver 400 in accordance with the present disclosure.

As shown in FIG. 4, transceiver 400 includes a transmitter portion (TX) and a receiver portion (RX). The transmitter portion includes an optical waveguide structure that includes multiple channels of optical waveguide modulators on a substrate. The receiver portion includes at least one surface light illuminated photodetector.

In the interest of brevity, features of transceiver 400 that are similar or identical to those of transceiver 310 and transceiver 320 are not described again herein.

Different from transceiver 310 and transceiver 320, in transceiver 400 a parallel structure is used without a multiplexing structure (e.g., multiplexer) or a de-multiplexing structure (e.g., de-multiplexer). In the example shown in FIG. 4, four modulators (MZ 1, MZ 2, MZ 3 and MZ 4) are integrated on the same chip, e.g., SOI chip, while the receiver portion includes four discrete photodetectors PD.

The transmitter portion of transceiver 400 also includes an array of CDR modules, an array of MZ drivers coupled to the array of CDR modules, a single chip of the optical waveguide multiplexing structure coupled to the array of MZ drivers, and an array of lenses coupled to the single chip of the optical waveguide multiplexing structure. Additionally, the transmitter portion of transceiver 400 may also include a laser, a first lens coupled to the laser, an isolator coupled to the first lens, and a second lens coupled between the isolator and the single chip of the optical waveguide multiplexing structure.

The receiver portion of transceiver 400 also includes an array of lenses, an array of PDs coupled to the array of lenses, an array of TIA modules coupled to the array of PDs, and an array of CDR modules coupled to the array of TIA modules. At least the CDR modules and the TIA modules may be CMOS and fabricated by CMOS process.

Additional Note

Although some embodiments are disclosed above, they are not intended to limit the scope of the present disclosure. It will be apparent to those skilled in the art that various modifications and variations can be made to the disclosed embodiments of the present disclosure without departing from the scope or spirit of the present disclosure. In view of the foregoing, the scope of the present disclosure shall be defined by the following claims and their equivalents.

What is claimed is:

1. A transceiver, comprising:
a transmitter portion comprising an optical waveguide structure, the optical waveguide structure comprising multiple channels of optical waveguide modulators on a substrate; and
a receiver portion comprising at least one surface light illuminated photodetector.

2. The transceiver of claim 1, wherein the transmitter portion further comprises an optical waveguide multiplexing structure, and wherein the multiple channels of optical waveguide modulators are integrated with the optical waveguide multiplexing structure into an optical channel for transmission.

3. The transceiver of claim 1, wherein the transmitter portion further comprises an optical waveguide multiplexing structure, and wherein the multiple channels of optical waveguide modulators are arranged in parallel with the optical waveguide multiplexing structure into multiple channels of couplers on the substrate.

4. The transceiver of claim 1, wherein the multiple channels of optical waveguide modulators comprise Si modulators, Ge/Si modulators, or element III-V based modulators.

5. The transceiver of claim 1, wherein the substrate comprises a Si substrate, and wherein the multiple channels of optical waveguide modulators comprise Si modulators.

6. The transceiver of claim 2, wherein the optical waveguide multiplexing structure comprises an arrayed waveguide grating (AWG), ring filter, echelle grating, or cascaded multiple stages of filters on the substrate.

7. The transceiver of claim 1, wherein the optical waveguide structure comprises multiple channels of lasers on a substrate.

8. The transceiver of claim 7, wherein the transmitter portion further comprises an optical waveguide multiplexing structure, and wherein the multiple channels of lasers are integrated with the optical waveguide multiplexing structure into an optical channel.

9. The transceiver of claim 7, wherein the transmitter portion further comprises an optical waveguide multiplexing structure, and wherein the multiple channels of lasers are arranged in parallel with the optical waveguide multiplexing structure into multiple channels of couplers on the substrate.

10. The transceiver of claim 7, wherein the multiple channels of lasers comprise element III-V based lasers.

11. The transceiver of claim 7, wherein the substrate comprises an element III-V substrate, and wherein the multiple channels of lasers comprise element III-V based lasers.

12. The transceiver of claim 8, wherein the optical waveguide multiplexing structure comprises an arrayed waveguide grating (AWG), ring filter, echelle grating, or cascaded multiple stages of filters on the substrate.

13. The transceiver of claim 1, wherein the receiver portion comprises a plurality of surface illuminated devices and a discrete optical de-multiplexing structure, and wherein the surface illuminated devices are connected with the discrete optical de-multiplexing structure to form an optical channel for receiving.

14. The transceiver of claim 13, wherein the surface illuminated devices comprise Ge/Si photodetectors or element III-V photodetectors.

15. The transceiver of claim 13, wherein the surface illuminated devices comprise discrete photodetectors or a detector array.

16. The transceiver of claim 13, wherein the discrete optical de-multiplexing structure comprises a thin film filter.

17. The transceiver of claim 1, wherein the receiver portion comprises a plurality of surface illuminated devices and a discrete optical de-multiplexing structure, and wherein the surface illuminated devices and the discrete optical de-multiplexing structure are arranged in parallel into multiple fibers.

18. The transceiver of claim 17, wherein the surface illuminated devices comprise Ge/Si photodetectors or element III-V photodetectors.

19. The transceiver of claim 17, wherein the surface illuminated devices comprise discrete photodetectors or a detector array.

20. The transceiver of claim 17, wherein the discrete optical de-multiplexing structure comprises a thin film filter.
